(19) United States
(12) Patent Application Publication
(10) Pub. No.: US 2013/0326866 A1
(43) Pub. Date: Dec. 12, 2013

(54) Manual Workstation and Worker Guidance Method

(71) Applicant: Robert Bosch GmbH, Stuttgart (DE)

(72) Inventor: Martin Authenrieth, Oehringen (DE)

(21) Appl. No.: 13/910,593

(22) Filed: Jun. 5, 2013

(30) Foreign Application Priority Data
Jun. 8, 2012 (DE) 10 2012 011412.5

(51) Int. Cl. B23P 19/04

(52) U.S. Cl. CPC B23P 19/04
USPC 29/700

(57) ABSTRACT

A manual workstation has a tool system, which has a manually guided tool for processing a workpiece, and a worker guidance device, which has at least one illumination device which is designed to generate a spot of light on a workpiece to be processed and to adjust the position of the spot of light. The worker guidance device is equipped to indicate an assembly point on the workpiece to be processed by means of the spot of light.

The present disclosure relates to a manual workstation and a worker guidance method.

### BACKGROUND

During screw assembly processes in manual workstations there is often the requirement that screw fixing points must be processed in a fixedly predefined order (working order). This is the case, for example, when units have to be fitted to an internal combustion engine in a specific order. In addition, by complying with a fixed order of screwing operations, it is possible to avoid stresses occurring on the workpiece. One example of this is the cylinder head assembly in repair workstations.

In order to make it easier to comply with the correct order, worker guidance systems can be used. For example, the position of the next screw fixing point can be displayed to the worker on a monitor. However, the worker has to look away from the workpiece for this purpose. Depending on the type and size of the display on the monitor, the allocation of the screw fixing point on the workpiece may be more or less difficult and can lead to errors in the processing.

In addition, the current position of the screw fixing tool can be determined and this can be blocked or enabled by the screw fixing control if said tool is in the intended position. Only after enabling can the worker operate the tool. In order to determine the position, ultrasonic methods or else camera-based (image-processing) systems can be used.

It is desirable to improve the indication of the working order for the worker.

### SUMMARY

According to the disclosure, a manual workstation and a worker guidance system has the features disclosed herein. Advantageous refinements are the subject matter of the following description.

The system makes use of the measure of indicating the respective next assembly point to the worker not indirectly, for example via a monitor, but directly on the workpiece itself. For this purpose, use is expediently made of a worker guidance device having at least one illumination device, which locally illuminates the respective next assembly point. This can involve spot illumination but also point illumination, for example by means of a focused light beam or laser beam. The worker therefore no longer has to look away from the workpiece but can continue to work continuously. The assembly speed is increased. As a result of the indication directly on the workpiece, no allocation errors can occur, the assembly result is improved. A spot of light which can be allocated to the assembly point is generated. Expediently, a spot of light is generated at or close to the assembly point.

In an advantageous development, the tool of the tool system, for example an inserter of a screw fixing system, can be equipped with an optical receiver and the tool system can have a control apparatus which enables operation of the tool only when the optical receiver receives light emitted by the illumination device. The light can in particular be encoded, for example frequency- or PWM-modulated, so that the control apparatus can detect the reception of the correct light. For instance, an enable signal can be transmitted to the tool via the light beam. The tool can be started by the worker only when said tool is at the assembly point.

The control apparatus of the tool system is preferably connected to the control apparatus of the worker guidance device by means of a data link, e.g. cable-bound or cable-less. In this way it can be established in particular whether the tool is at the correct assembly point, so that an enable signal can be given. In this way, feedback from the tool system to the worker guidance device that the assembly point is being processed can preferably also be given, for example by the worker actuating a switching element on the tool or tool system. The next assembly point can then be indicated. The feedback can also be provided automatically, for example via a determination of torque, i.e. the current assembly point is detected as processed when a torque threshold value is reached.

According to a particularly preferred embodiment, the worker guidance device indicates to the worker the position of the next assembly point on the workpiece. If the tool is in the correct position, which can be checked in particular via the above-described optical receiver, the tool system informs the worker guidance device via the above-described data link that the tool is in the intended position.

Then the enabling of the tool is arranged (e.g. via the worker guidance device). The worker starts the working procedure via an actuating element (“start switch”) of the tool and keeps the actuating element actuated until the tool signals that the working procedure has been processed, for example by means of torque monitoring. An assembly (for example screw fixing) that has been carried out correctly is signaled, for example, by means of a light signal (e.g. green LED); if the assembly could not be carried out properly, this is signaled via another light signal (e.g. red LED). At the same time, the tool system passes this information on to the worker guidance device via the above-described data link. At the same time, the assembly parameters (e.g. torque reached, insertion angle, insertion time, etc.) can also be transmitted to a higher-order line control system, e.g. by means of a field bus.

The tool system is preferably driven on the basis of the assembly point; in particular assembly point-specific parameters, such as a torque, can be transmitted to the tool.

Further advantages and refinements of the disclosure can be gathered from the description and the appended drawing.

It goes without saying that the features mentioned above and those still to be explained below can be used not only in the respectively specified combination but also in other combinations or on their own without departing from the context of the present disclosure.

The disclosure is illustrated schematically in the drawing by using an exemplary embodiment and will be described extensively below with reference to the drawing.

### BRIEF DESCRIPTION OF THE DRAWING

FIG. 1 shows a manual workstation according to a preferred embodiment of the disclosure.

### DETAILED DESCRIPTION

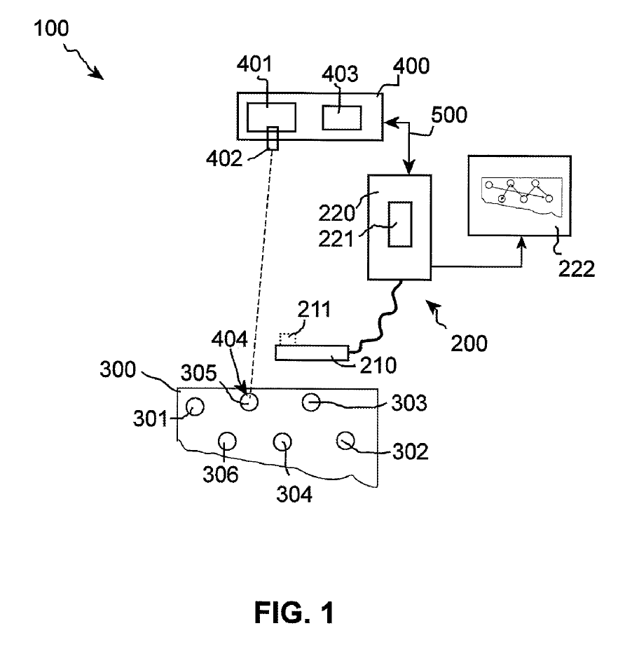

In FIG. 1, a preferred embodiment of a manual workstation according to the disclosure is illustrated schematically and designated overall by 100. The manual workstation has a tool system 200 which, here, is constructed as a screw fixing system. The screw fixing system 200 has a manually guided inserter 210 as tool, which is connected to a tool control unit 220 via a cable connection. The tool control unit 220 has a control apparatus 221 (in particular a computing unit with computer program), which controls the screw fixing system 200.

The screw fixing system 200 is used to perform screw fixings 301 to 306 on a workpiece 300, compliance with a correct order being desired. For example, the control apparatus 221 of the screw fixing system 200 can therefore be equipped to display the working order, i.e. the order of screw fixings to be made, to the worker on an associated monitor 222. The correct order of the assembly points is indicated here by arrows by way of example. Screw fixing systems 200 of this type are in principle known in the prior art and are therefore not to be explained in more detail at this point.

In order to make this work easier for the worker, the manual workstation 100 further has a worker guidance device 400, which has at least one illumination device 401 with, in the present example, an arrangement 402 comprising a laser light source and a scanning mirror. The worker guidance device 400 also has a control apparatus 403, which is equipped to drive the worker guidance device 400. It should be mentioned that an LED light source or incandescent lamp can also be used.

The arrangement 402 is capable of generating a spot of light 404 on the workpiece 300 to be processed and positioning said spot substantially optionally. The way in which a laser light source can be operated appropriately with a scanning mirror is likewise fundamentally known in the prior art. Instead of a scanning mirror, the light source itself can also be mounted such that it can pivot in two axes. In addition, other possibilities are also known, for example that a carriage having a light source is displaced linearly and the light source is pivoted on the carriage, such as is employed for example in paternoster stores to indicate the removal compartment. As a result, for example, the x position of the spot of light is reached by moving the light source, the y position by pivoting the same.

Within the context of the disclosure, the control apparatus 403 of the worker guidance device 400 is equipped to drive the illumination device 401 such that the spot of light 404 is positioned on or close to the assembly point 301 to 306 that is to be processed at that moment. In the depiction according to FIG. 1, the spot of light 404 is positioned precisely on the assembly point 305. As a result, the assembly point to be processed next is indicated to the worker.

According to a preferred development, the inserter 210 can have a photo receiver 211, illustrated with dashes here. The control apparatus 221 of the screw fixing system 200 can be equipped to block actuation of the tool 210 if the tool 210 is not located at the assembly point 305 indicated, i.e. if the spot of light 404 does not strike the photo receiver 211. If the photo receiver 211 is struck by the spot of light 404, however, actuation of the inserter 210 is enabled. In order to ensure correct allocation of an inserter 210 to a worker guidance device 400, the illumination device 401 can be equipped to emit encoded light (e.g. frequency- or PWM-modulated). As a result, the tool 210 and the tool control unit 220 can detect whether the tool 210 is located at the correct assembly point.

Between the tool control unit 220 and the worker guidance device 400, a cable-bound or cable-less data link 500 can be set up in order to permit data exchange between tool system 200 and worker guidance device 400. In this way, for example, feedback from the tool system 200 to the worker guidance device 400 that the current assembly point has been processed is carried out. This can be done manually (e.g. by actuating a switching element (not shown) on the tool or the tool control system) or preferably automatically, as explained above. The next assembly point on the workpiece 300 can then be indicated.

What is claimed is:

1. A manual workstation comprising:
a tool system having a manually guided tool configured to process a workpiece; and
a worker guidance device including at least one illumination device configured to generate a spot of light on the workpiece to be processed and to adjust a position of the spot of light,
wherein the spot of light indicates an assembly point on the workpiece to be processed.

2. The manual workstation according to claim 1, wherein the worker guidance device includes a control apparatus configured to drive the at least one illumination device such that the spot of light is positioned on or close to the assembly point.

3. The manual workstation according to claim 1, wherein the tool system includes a control apparatus configured to transmit a position of the assembly point to the worker guidance device.

4. The manual workstation according to claim 1, wherein the assembly point is a respective next assembly point.

5. The manual workstation according to claim 1, wherein the at least one illumination device includes one of a laser and a LED light source.

6. The manual workstation according to claim 1, wherein:
the tool includes a photo receiver, and
the tool system is configured to block actuation of the tool if the tool is not located at the assembly point.

7. The manual workstation according to claim 1, wherein the at least one illumination device is configured to emit an encoded light beam.

8. The manual workstation according to claim 7, wherein the encoded light beam emitted by the at least one illumination device transmits data to the tool.

9. The manual workstation according to claim 1, wherein:
the tool system includes a screw fixing system, and
the tool includes a manually guided inserter.

10. The manual workstation according to claim 1, wherein the illumination device includes a positioning device configured to optionally position the spot of light on the workpiece.

11. A worker guidance method comprising:
indicating a respective next assembly point on a workpiece with a spot of light on the workpiece.

12. The worker guidance method according to claim 11, further comprising:
generating the spot of light on the workpiece with at least one illumination device of a worker guidance device of a manual workstation;
adjusting a position of the spot of light with the at least one illumination device; and
processing the workpiece with a manually guided tool of a tool system of the manual workstation.

13. The manual workstation according to claim 10, wherein the positioning device includes one of a scanning mirror and a pivoting device.
